(19) United States
(12) Patent Application Publication
(10) Pub. No.: US 2022/0345591 A1
(43) Pub. Date: Oct. 27, 2022

(54) Underwater Camera Operations

(71) Applicants: David Shau, Sunnyvale, CA (US); Jeng-Jye Shau, Sunnyvale, CA (US)

(72) Inventors: David Shau, Sunnyvale, CA (US); Jeng-Jye Shau, Sunnyvale, CA (US)

(21) Appl. No.: 17/238,185

(22) Filed: Apr. 22, 2021

(51) Int. Cl. H04N 5/14; H04N 5/225; G03B 17/08; H04N 5/235; H04N 5/232

(52) U.S. Cl. CPC H04N 5/144; H04N 5/2252; G03B 17/08; H04N 5/22521; H04N 5/2254; H04N 5/2354; H04N 5/23296

(57) ABSTRACT

Camera operations are controlled by motion patterns determined from the outputs of an internal motion sensor. These methods remove the need for a nob, button, touch screen, or other mechanical control devices with movable components. This effectively removes common water leakage weak points for electronic devices with cameras. Motion patterns determined from the outputs of an internal motion sensor are also used to adjust camera operation parameters such as the brightness of a supporting light source, shutter speed, aperture opening, and contrast. These methods are also applicable for land operations.

### BACKGROUND OF THE INVENTION

The present invention relates to camera control methods, and more particularly to underwater camera control methods.

A camera is an optical instrument used to record images. At their most basic, cameras are sealed boxes (the camera body) with a small hole (the aperture). The aperture allows light into the camera body, and captures an image on a light-sensitive surface (which is usually photographic film or a digital light sensor). Cameras have various mechanisms to control how the light falls onto the light-sensitive surface: lenses focus the light entering the camera, aperture size can be widened or narrowed to allow more or less light into the camera, and a shutter mechanism determines the amount of time the light-sensitive surface is exposed to light.

An electronic camera is a camera that captures images using electronic light sensors. A digital camera is an electronic camera that has a digital interface for outputting digital electronic data that represents captured images. Most cameras produced today are digital in contrast to film cameras. Digital cameras utilize an optical system that typically uses a lens with an adjustable diaphragm to focus light onto an image pickup device. The image pickup device functions similarly to the light-sensitive surfaces mentioned previously, with the camera diaphragm and shutter admitting the correct amount of light for the image pickup device. Unlike film cameras, digital cameras can display images on a video display device immediately after being recorded, and can also store or delete images. Many digital cameras can also record videos with sound, and some digital cameras can also crop and edit pictures.

Underwater cameras are used to take photographs while underwater. Activities such as scuba diving, snorkeling, or swimming require underwater cameras for photography, and underwater cameras are protected by water-resistant enclosures that protect camera components from water damage. Typically, such water-resistant enclosures have moveable mechanical components, such as control knobs or buttons, that must make physical contact with the inner camera electronics. These mechanical components are weak points of water-resistant enclosures—water leakage is most prone to occur at areas where there is a moveable mechanical part such as those mentioned above. Typically, such weak points are made waterproof by placing silicone or other elastomer O-rings at the crucial joints. Sometimes double O-rings are used on many of the critical pushbuttons and spindles to reduce the risk of water leakage. These structures used to prevent water leakage increase the size and cost of an underwater camera and are difficult to use. It is therefore highly desirable to devise a method for controlling underwater cameras without using mobile control knobs or other moveable mechanical components.

Many cameras are now incorporated into mobile devices like smartphones, which can, among many other purposes, use their cameras to capture photos, videos, and initiate videotelephony. Such embedded cameras can be operated with contactless control methods such as voice recognition and Bluetooth wireless control. However, voice recognition methods are not suitable for underwater control because it is infeasible to speak clearly to a microphone in such conditions. In addition, electromagnetic (EM) waves used for Bluetooth communication are extremely unreliable underwater. Other common control methods such as touch screen control are also not as reliable underwater as they are on land. It is therefore highly desirable to develop different contactless control methods to operate cameras underwater.

Kossin in U.S. Pat. No. 9,225,883 disclosed devices that use hall effect sensors to control underwater cameras. Magnetic fields can penetrate through the water-resistant enclosure of an underwater camera, thereby allowing the device to operate under magnetic control rather than mechanical control. However, it is still desirable to control cameras underwater without needing to use buttons. Kossin also mentions the use of optical switches to control underwater cameras. While light is able to penetrate transparent water-resistant enclosures, the light source itself still requires an electrical power source, which also requires its own water-resistant enclosure. It is therefore desirable to control an underwater camera without using external devices that also need water protection.

As defined herein, the gravity acceleration vector (g) is a vector that points towards the center of gravity of the Earth, with an amplitude equal to approximately 9.8 meters/second². An electric motion sensor is an electronic device that provides electrical outputs that are related to the motion of the motion sensor. Three of the most commonly used electric motion sensors are accelerometers, compasses and gyroscopes. An accelerometer, as used herein, is an electronic device that provides electrical outputs that are approximately proportional to the vector components of (Acc+g), where Acc is the acceleration vector experienced by the accelerometer, and g is the gravity acceleration vector. Typical accelerometers measure the vector components (Ax, Ay, Az) of (Acc+g) along three vertical axes (x, y, z) defined by the devices. Ax is the magnitude of the vector component of (Acc+g) along the x-axis and is equal to the dot product of (Acc+g) and the unit vector along the x-axis. Ay is the vector component of (Acc+g) along the y-axis and is equal to the dot product of (Acc+g) and the unit vector along the y-axis. Az is the vector component of (Acc+g) along the z-axis and is equal to the dot product of (Acc+g) and the unit vector along the z-axis (some accelerometers measure the vector components (Ax, Ay) along two vertical axes without the third axis). When the amplitude of Acc is close to zero, vector (Ax, Ay, Az) becomes equivalent to g, and the outputs of an accelerometer can be used to determine the orientation of the motion sensor relative to the gravity acceleration vector (g). Therefore, accelerometers are often called g-sensors. A gyroscope is a device used for measuring or maintaining orientation and angular velocity. An electronic gyroscope is a gyroscope that has an electronic interface to provide outputs in electronic signals; sometimes electronic gyroscopes are also called gyrometers. An electronic compass is a magnetometer that has an electronic interface to provide outputs in electronic signals that are related to the orientation of the device relative to nearby magnetic field. A portable electronic device is an electronic device that comprises an internal battery and is able to function without using external electrical power sources other than the internal battery. The term “portrait orientation” describes the orientation of a rectangular image where the height of the display area is greater than the width, while the term “landscape orientation” describes the orientation of a rectangular image where the width of the display area is greater than the height.

As defined herein, a cursor is a movable indicator on a video display identifying the point that will be affected by input from the user, while a pointer is a rotatable indicator on a video display identifying the direction which will be affected by input from the user.

### SUMMARY OF THE PREFERRED EMBODIMENTS

A primary objective of the preferred embodiments is, therefore, to control underwater cameras without using movable mechanical components such as control knobs or buttons. This will reduce the size and cost of underwater cameras while also achieving excellent underwater protection. Another primary objective is to control underwater cameras without using external devices that also need water protection. Another objective is to provide contactless control mechanisms to adjust the brightness of light sources. Another objective is to have convenient control methods that are useful not only underwater but also above water. These and other objectives of the preferred embodiments are achieved by monitoring and analyzing the outputs of a motion sensor to control camera operations.

While the novel features of the invention are set forth with particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1(a) shows the rear-facing view of one example of a portable electronic device equipped with a camera and a motion sensor;

FIG. 1(b) shows the front-facing view of the device in FIG. 1(a) in portrait orientation;

FIG. 1(c) shows the front-facing view of the device in FIG. 1(a) in landscape orientation;

FIG. 1 (d) shows a simplified cross-section view of the device in FIG. 1(a);

FIGS. 2(a-d) illustrate exemplary procedures for selecting application programs by using a pointer controlled by an exemplary motion control algorithm of the present invention;

FIGS. 2(e-h) illustrate exemplary procedures for selecting application programs by using a cursor controlled by an exemplary motion control algorithm of the present invention;

FIGS. 3(a-h) illustrate exemplary procedures of the present invention for controlling operations such as zooming in, zooming out, taking pictures, and playing videos;

FIG. 4(a) is an exemplary flow chart for the control algorithm illustrated in FIG. 2(a-d);

FIG. 4(b) is an exemplary flow chart for the control algorithm illustrated in FIG. 2(e-h);

FIG. 4(c) is an exemplary flow chart for the control algorithm illustrated in FIG. 3(a-h);

FIG. 4(d) is a flow chart for an exemplary brightness adjustment algorithm for a light source;

FIG. 4(e) is a flow chart for an exemplary camera parameter adjustment algorithm;

FIG. 4(f) is an exemplary flow chart for camera switching operations;

FIG. 5(a) shows exemplary motion sensor output waveforms for the example illustrated in FIGS. 2(a-d);

FIG. 5(b) shows exemplary motion sensor output waveforms for the example illustrated in FIGS. 3(a-h); and

FIG. 5(c) shows exemplary motion sensor output waveforms when the motion sensor detects three consecutive forward pushes and two consecutive backward pulls.

### DETAILED DESCRIPTION OF THE PREFERRED EMBODIMENTS

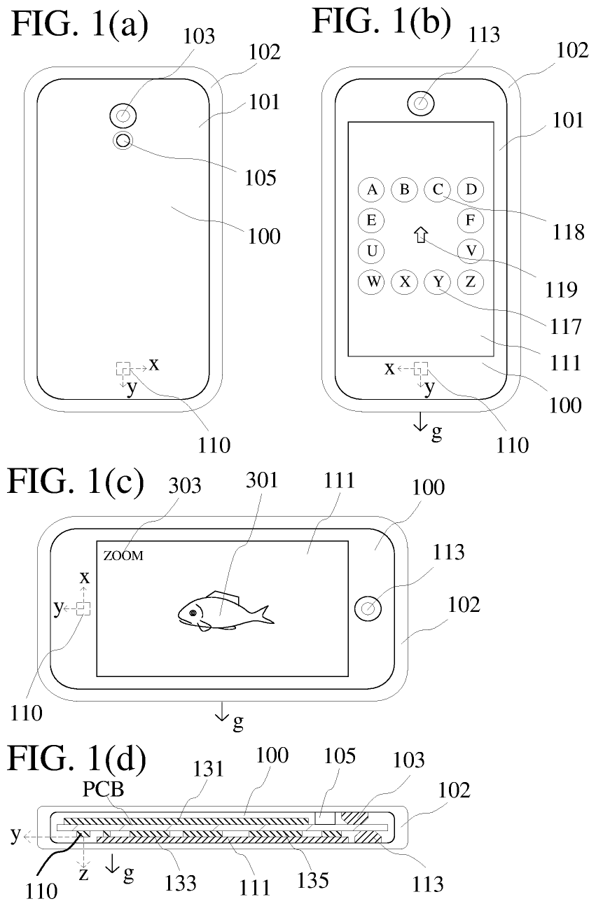

FIG. 1(a) shows the rear-facing view of a portable electronic device (100). A case (101) similar to cases used by mobile phones encloses all electronic components of the device (100), while a transparent water-resistant enclosure (102) encloses the case (101), protecting the electronic device from water. A digital camera (103) is visible in this rear-facing view; the viewing direction of this camera (103) is looking out away from this device (100), and this camera (103) will be called the “rear-facing camera” in the following discussions. A light source (105) is placed near the digital camera (103) to provide illumination for the camera. A typical example of such a light source (105) is a light-emitting-diode (LED) with brightness that can be controlled electrically. In this example, a motion sensor (110) that has three measurement axes (x, y, z) is placed inside this portable electronic device (100). The orientations of the (x, y) measurement axes of the motion sensor (110) are shown in FIG. 1(a). An accelerometer is a possible embodiment of this motion sensor (110), but other motion sensors can include but are not limited to gyroscopes and compasses.

FIG. 1(b) shows the front-facing view of the device in FIG. 1(a). Another digital camera (113) is visible in this view. The viewing direction of this camera (113) is towards the user of this electronic device and the front of his/her face; this camera (113) will therefore be referred to as the “front-facing camera” in the following discussions. A video display (111) is also placed on the front-side, as shown in FIG. 1(b). This video display (111) can display images captured by cameras (103, 113) and other images or forms of media such as web images, movies, and videos. For the example in FIG. 1(b), the video display is held in “portrait orientation” and displays 12 icons (117, 118) representing shortcuts to mobile applications and a pointer (119). With this orientation, the y measurement axis of the motion sensor (110) points in about the same direction as the g vector, as shown in FIG. 1(b).

FIG. 1(c) shows the same device in FIG. 1(b) held in “landscape orientation.” In landscape orientation, the x measurement axis of the motion sensor (110) points in the direct opposite direction of the g vector, as shown in FIG. 1(c). In this example, the image of a fish (301) captured by the rear-facing camera (103) is displayed on the video display device (111), while an activity indicator (303) is displayed on the upper-left-hand corner, indicating the camera function currently being executed as shown by the example in FIG. 1(c).

FIG. 1(d) is a simplified diagram illustrating the cross-section of the portable electronic device (100) when placed with the front side down. The internal structures of the portable electronic device (100) can be seen and are not necessarily drawn to scale. In this orientation, the z measurement axis of the motion sensor (110) points in the direction of the g vector, as shown in FIG. 1(d). This cross-section view shows that a transparent water-resistant enclosure (102) completely encloses all the electrical components of the device, including a rear-facing camera (103), a front-facing camera (113), a light source (105), a video display device (111), a battery (131), and a printed circuit board (PCB). Electrical components such as a motion sensor (110), control circuits (133), memory device (135), and other components are mounted on the printed circuit board (PCB), including electrical circuits that can read the outputs of the motion sensor and control functions of the digital electronic camera. Examples for means that can read the outputs of the motion sensor and control functions of the digital electronic camera include various combinations of electrical circuits, firmware stored in control circuits (133), software stored in the memory device (135), and other types of control mechanisms.

While the preferred embodiments have been illustrated and described herein, other modifications and changes will be evident to those skilled in the art. For example, orientations of the motion sensor can be arranged differently, and the water-resistant enclosure can have openings for other components such as battery charging connections, USB ports, or audio phone jacks. It is to be understood that there are many other possible modifications and implementations so that the scope of the invention is not limited by the specific embodiments discussed herein.

The portable electronic device illustrated in FIGS. 1(a-d) is completely enclosed by a water-resistant, pressure-resistant enclosure (102). Such enclosures that are able to provide protection while deep underwater are typically made of transparent hard plastic materials, thereby rendering common control methods that use buttons, knobs, or a touch screen unreliable. It is therefore necessary to develop novel control methods to operate this device (100). For example, the conventional method to activate an application program (app) is to touch an icon (117, 118) of the app on the screen (111) with a finger. This method becomes unreliable when the video display (111) is covered by a water-resistant enclosure (102).

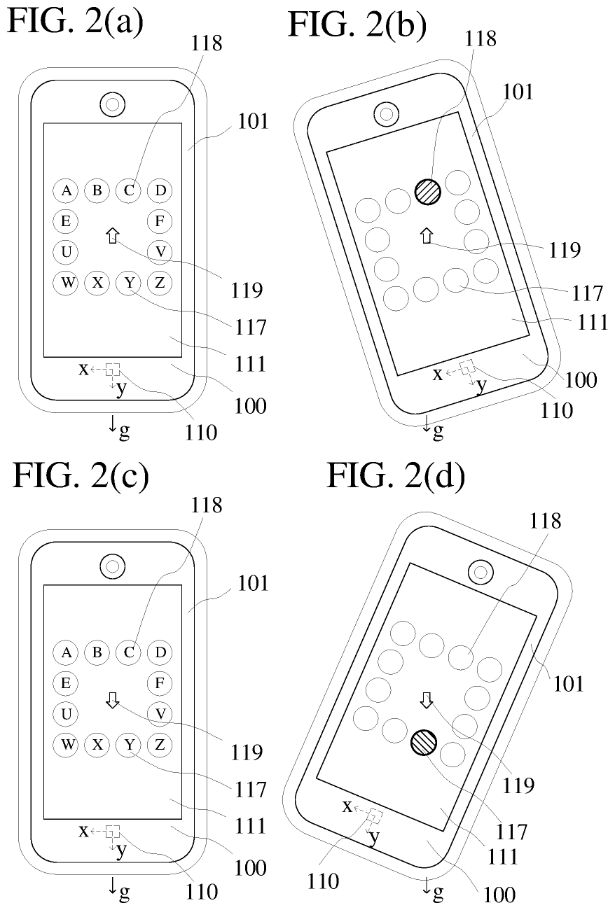

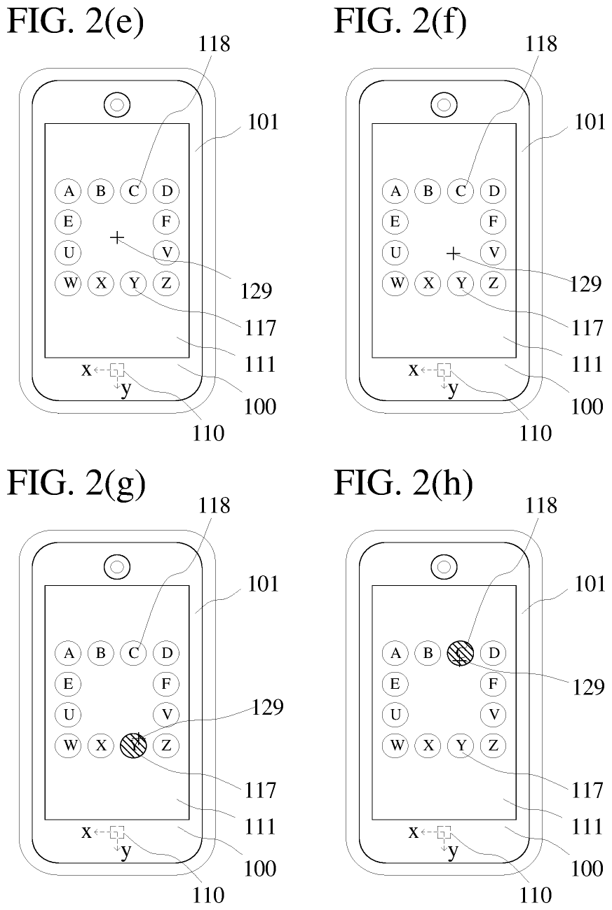

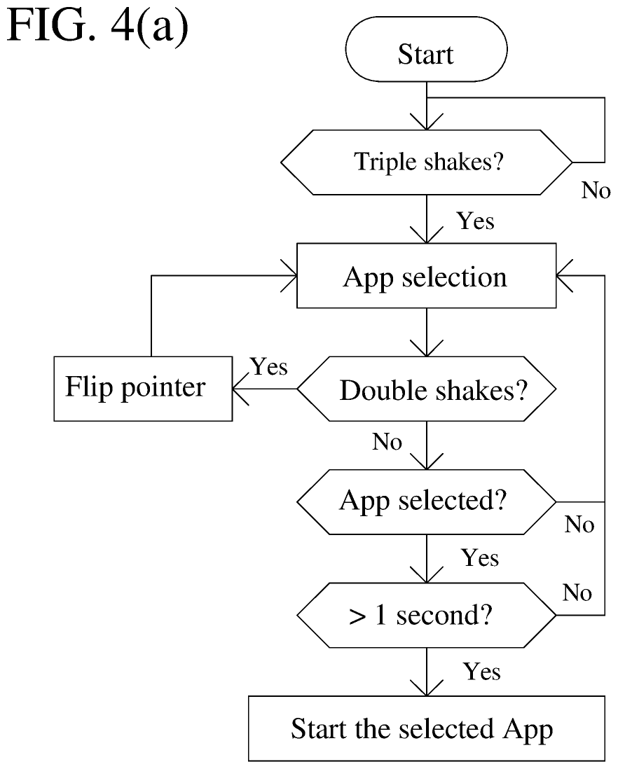

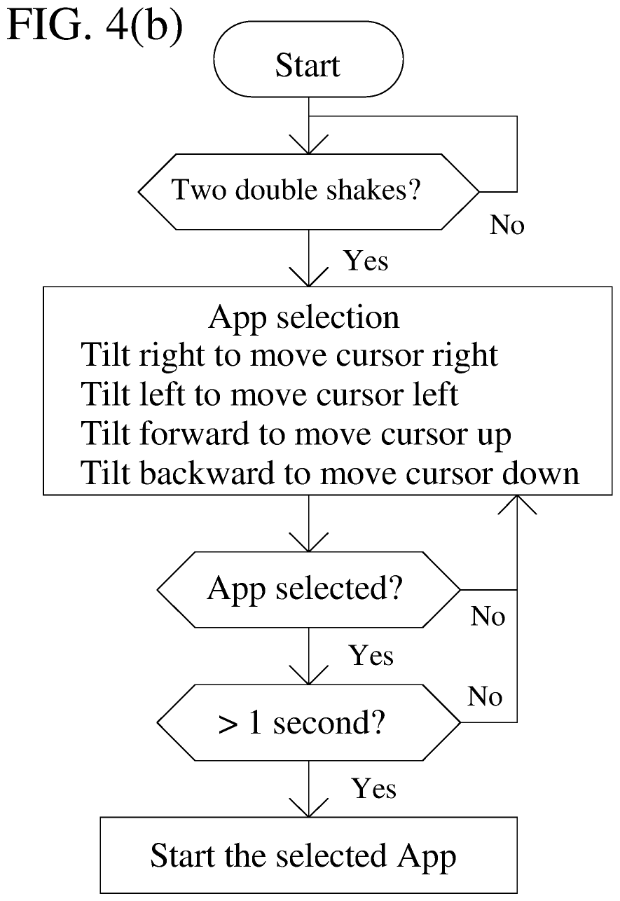

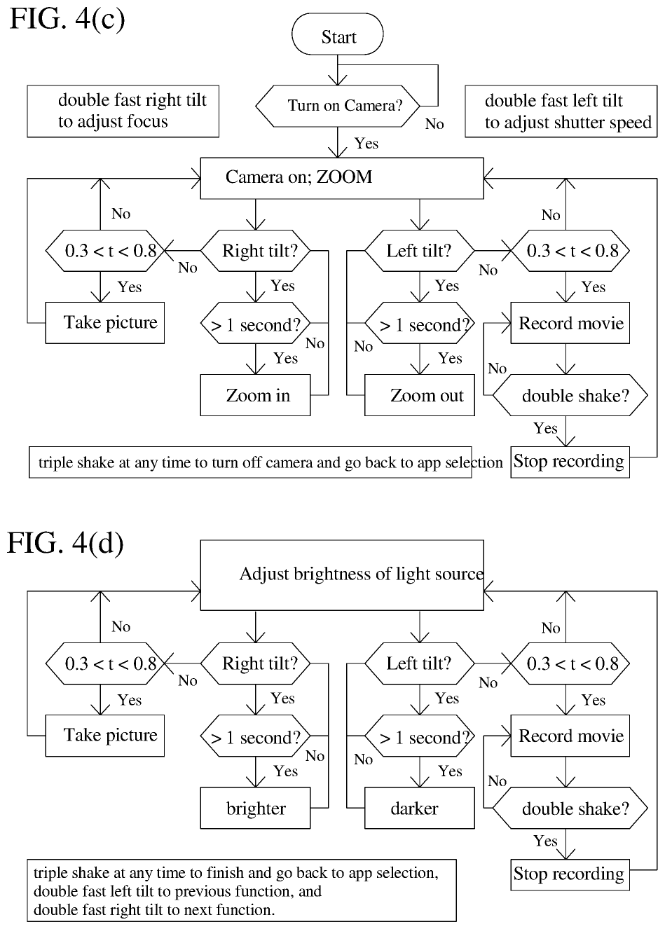

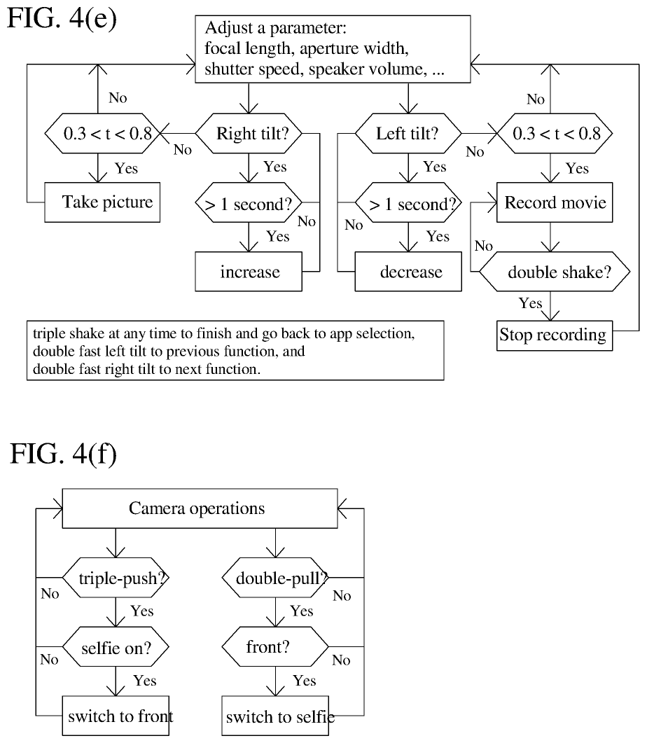

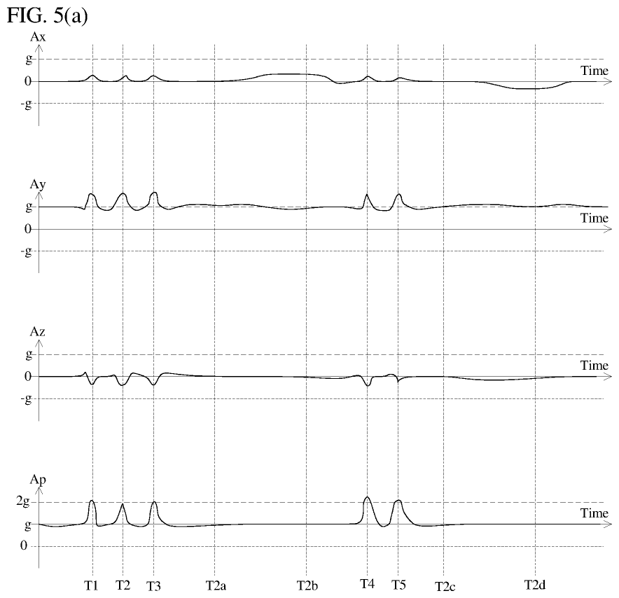

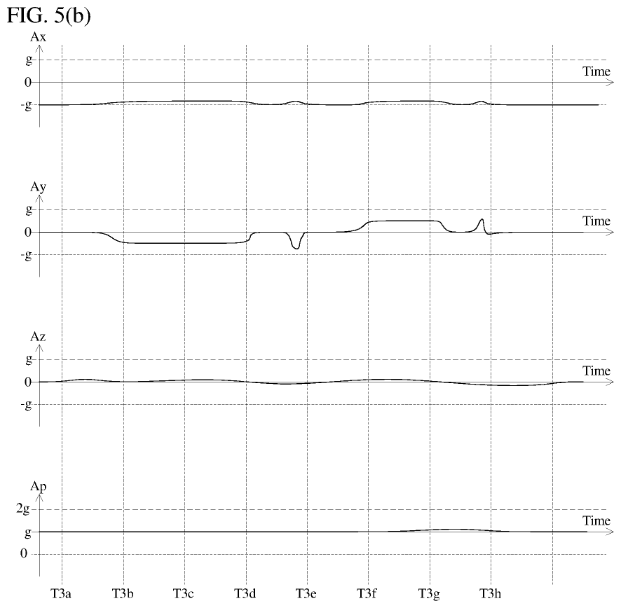

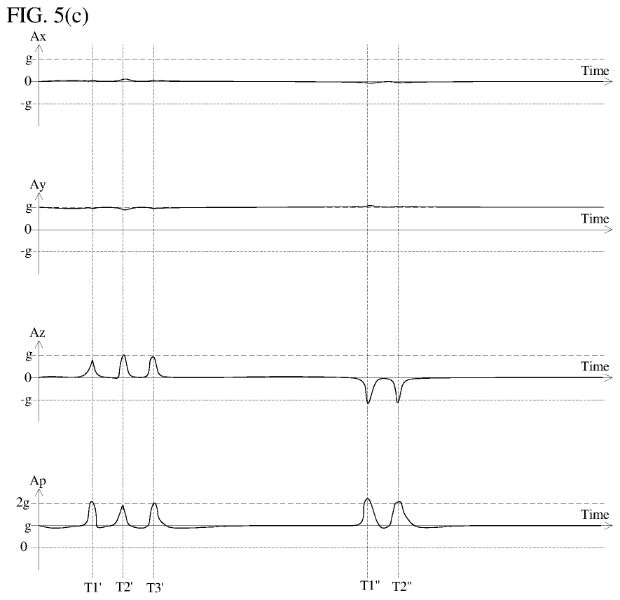

FIGS. 2(a-d), FIG. 4(a), and FIG. 5(a) illustrate a novel method to activate application programs. Initially, the portable electronic device (100) illustrated in FIGS. 1(a-d) is held still in portrait orientation as shown in FIG. 2(a), so that the x component (Ax) detected by the motion sensor (110) is approximately equal to zero, the y component (Ay) detected by the motion sensor is approximately equal to the magnitude of the gravity acceleration vector (g), and the z component (Az) detected by the motion sensor is approximately equal to zero, as shown by the waveforms in FIG. 5(a) before time T1. The vector amplitude (Ap) calculated as Ap=SQRT(Ax²+Ay²+Az²) is approximately equal to the amplitude of the gravity acceleration vector (g), as shown in FIG. 5(a) at time before T1. The user then shakes the portable electronic device (100) three times, as shown by the waveform in FIG. 5(a) at time T1, T2, and T3. When the device (100) is shaken or tapped, the three components (Ax, Ay, Az) detected by the motion sensor (110) will typically have short sudden pulses, as shown in FIG. 5(a) at time T1, T2, and T3. Experiments show that the amplitude (Ap) of the pulses caused by shaking are larger than the magnitude of the gravity acceleration vector (g), as shown in FIG. 5(a) at time T1, T2, and T3. According to the algorithm shown by the flow chart in FIG. 4(a), after this predefined motion pattern where the user shakes the phone three times consecutively is detected, the motion pattern triggers a pre-defined action to enter app selection mode. This motion pattern will be defined as the “triple shake” for the remaining discussions. At this time, the outputs (Ax, Ay, Az) of the motion sensor indicate portrait orientation, as shown in FIG. 5(a) at time T2a. During app selection mode, the video display (111) will display icons (117, 118) of available application programs and a pointer (119), as shown in FIG. 2(a). During the time interval between T2a and T4 shown in FIG. 5(a), the outputs (Ax, Ay, Az) of the motion sensor (110) are used to determine the orientation of the pointer (119) on the video display (111), where the pointer (119) always points in the opposite direction of the gravity acceleration vector (g), as shown in FIGS. 2(a, b). When the portable electronic device (100) is tilted left, as shown in FIG. 2(b), the Ax value increases. This can be seen by the waveform in FIG. 5(a) around time T2b. Using the outputs (Ax, Ay, Az) of the motion sensor (110), the tilting angle can be calculated to determine which app icon (118) the pointer (119) points at, and the app icon (118) pointed to by the pointer (119) is selected and highlighted, as shown in FIG. 2(b). If the same icon (118) remains selected for longer than 1 second, or any other predefined period of time, the application program represented by the selected icon (118) will be executed according to the flow chart in FIG. 4(a). During app selection mode, if the device (100) is shaken twice, as shown by the waveform in FIG. 5(a) around time T4 and T5, this pre-defined motion pattern, which will be referred to as the “double shake” for the remaining discussions, triggers a pre-defined action that flips the direction of the pointer (119) in the opposite direction. The outputs (Ax, Ay, Az) of the motion sensor (110) are then used to determine the orientation of the pointer (119) on the video display (111), where the pointer (119) always points in the same direction as the gravity acceleration vector (g) as illustrated in FIGS. 2(c, d), the flow in FIG. 4(a), and the waveforms in FIG. 5(a) after time T2c. At these times, if the portable electronic device (100) is tilted right, as shown in FIG. 2(d), the Ax value decreases as shown by the waveform in FIG. 5(a) at time T2d. Using the outputs (Ax, Ay, Az) of the motion sensor (110), the tilting angle can be calculated to determine which app icon (117) is pointed to by the pointer (119), and the app icon (117) pointed to by the pointer (119) is selected and highlighted as shown in FIG. 2(d). If the same icon (117) remains selected for longer than 1 second, or any other pre-defined period of time, the application program represented by the selected icon (117) will be executed according to the flow chart in FIG. 4(a).

While the preferred embodiments have been illustrated and described herein, other modifications and changes will be evident to those skilled in the art. For example, instead of changing the direction of a pointer (119), the motion of the device (100) also can be used to move a cursor on the video display (111) for app selection. Instead of using an accelerometer to calculate the device angle, a gyroscope can also be used to accomplish the same purpose. In addition to using the angle at which the device is tilted, other types of motion patterns can be used to move pointers or cursors for app selection. Instead of supporting underwater operations, the present invention can also support operations that are not underwater. It is to be understood that there are many other possible modifications and implementations so that the scope of the invention is not limited by the specific embodiments discussed herein.

FIGS. 2(e-h), illustrates another exemplary method to activate application programs. Instead of a pointer (119), a cursor (129) is used to select application programs. In this example, the cursor (129) is represented by a ‘+’ symbol, as shown in FIGS. 2(e-h). Other symbols also can be used to represent the cursor. According to the exemplary flow chart in FIG. 4(b), if the user shakes the mobile device two times within 1 second of each other, an app selection mode with a cursor as the selector is triggered. Initially, the cursor (129) starts at the center location of the video display (111), as shown in FIG. 2(e). The video display (111) will display icons (117, 118) of available application programs, as shown in FIGS. 2(e-h). The outputs (Ax, Ay, Az) of the motion sensor (110) are then used to determine the movement of the cursor (129). When the device is tilted right, the cursor moves right; when the device is tilted left, the cursor moves left; when the device is tilted forward, the cursor moves up; when the device is tilted backward; the cursor moves down, as shown by the flow chart in FIG. 4(b). In this example, the cursor (129) was first moved down and to the right of the center location, as shown in FIG. 2(f). Next, the cursor (129) is moved further down such that it overlaps with an app icon (117), as shown in FIG. 2(g). Next, the cursor (129) is moved up such that it overlaps with another app icon (118), as shown in FIG. 2(h). Icons (117, 118) are selected and highlighted when the cursor (129) overlaps with them, as shown in FIGS. 2(g, h). If the same icon (117, 118) remains selected for longer than 1 second, or any other pre-defined period of time, the application program represented by the selected icon (117, 118) will be executed according to the flow chart in FIG. 4(b).

While the preferred embodiments have been illustrated and described herein, other modifications and changes will be evident to those skilled in the art. In addition to selecting apps, other functions also can be executed through combinations of pre-defined motion patterns detected by a motion sensor. In addition, multiple motion sensors of various types also can be used to support similar functions rather than just one. It is to be understood that there are many other possible modifications and implementations so that the scope of the invention is not limited by the specific embodiments discussed herein.

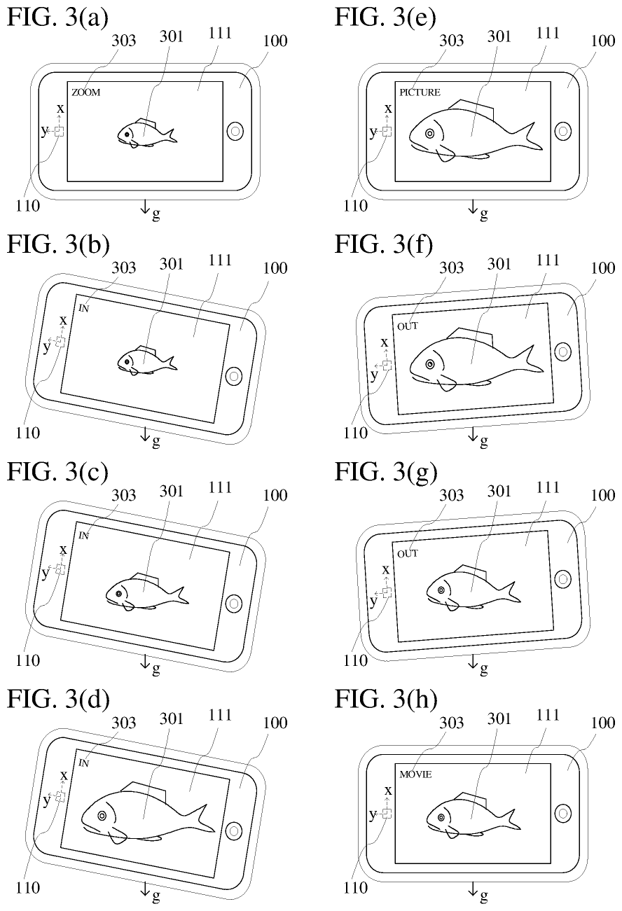

The flow chart in FIG. 4(c), the waveforms in FIG. 5(b), and FIGS. 3(a-h) provide exemplary illustrations for a novel method to operate a camera. Using the app selection procedures illustrated in FIGS. 2(a-d) or in FIGS. 2(e-h), a camera application program (118) can be executed with the rear-facing camera (103) turned on. The image of a fish (301) captured by the rear-facing camera (103) is displayed on the video display (111), as shown by FIG. 3(a). In this example, the portable electronic device (100) is held in landscape orientation, as illustrated in FIGS. 3(a-h). An activity indicator (303) is displayed near the upper left corner of the video display (111) to indicate that the camera function is currently operating, as shown in FIGS. 3(a-h). Initially, the indicator (303) displays the text “ZOOM,” indicating that the camera is ready to support zoom-in and zoom-out functions, as shown in FIG. 3(a). When the portable electronic device (100) is held still in landscape orientation, the x component (Ax) detected by motion sensor (110) is approximately equal to the negative of the gravity acceleration vector (g), the y component (Ay) detected by the motion sensor is approximately equal to zero, the z component (Az) detected by the motion sensor is approximately equal to zero, and the vector magnitude (Ap) calculated as Ap=SQRT(Ax²+Ay²+Az²) is approximately equal to the magnitude of the gravity acceleration vector (g), as shown in FIG. 5(b) at time T3a. In this ZOOM mode, if the device (100) is tilted right, as shown in FIG. 3(b), then the y component (Ay) of the outputs of the motion sensor (110) will decrease as shown by the waveform in FIG. 5(b) near time T3b. The tilting angle can be calculated using the outputs (Ax, Ay, Az) of the motion sensor (110). If the tilting angle is within a pre-defined range, such as between 15 degrees and 45 degrees, this pre-defined motion will trigger a zoom-in operation, causing the activity indicator (303) to display “IN,” as shown in FIG. 3(b). According to the algorithm shown by the flow chart in FIG. 4(c), if the tilting angle remains in the pre-defined range for longer than one second, or any other pre-defined period of time, the display will zoom in and cause the image of the fish (301) to magnify, as shown in FIG. 3(c). The corresponding waveforms of the motion sensor outputs during this situation are shown in FIG. 5(b) at time T3c. The longer the device remains in this tilted angle, the more the camera will zoom in, and the more the image of the fish (301) will magnify, as shown in FIG. 3(d). The corresponding waveforms of the motion sensor outputs are shown in FIG. 5(b) around time T3d. This zoom-in action will cease if the tilting angle becomes out of range, or when the camera (103) reaches maximum magnification. In this example, the portable electronic device (100) is tilted back to landscape orientation, and the image (301) on the video display (111) remains constant at the last magnification, as shown in FIG. 3(e). At landscape orientation in camera mode, if the device (100) is tilted right for a time shorter than 0.8 seconds and longer than 0.3 seconds (or some other pre-defined time interval) and then moves back to landscape orientation, then the camera will be triggered to take one picture and the activity indicator (303) will change to display “PICTURE,” as shown in FIG. 3(e). This logic can be seen in the flow chart in FIG. 4(c). Corresponding waveforms for this picture taking motion pattern are shown in FIG. 5(b) around time T3e.

In this zoom mode, if the device (100) is tilted left, as shown in FIG. 3(f), then the y component (Ay) of the motion sensor outputs (110) will increase, as shown by the waveform in FIG. 5(b) near time T3f. The outputs (Ax, Ay, Az) of the motion sensor (110) can then be used to calculate the tilting angle. In this example, the ratio Ax/Ay can be used to calculate the tilting angle. If the tilting angle is within a pre-defined range, such as between 15 degrees and 45 degrees, then this pre-defined motion of tilting left will trigger a zoom-out operation and cause the activity indicator (303) to display “OUT,” as shown in FIG. 3(f). According to the algorithm described by the flow chart in FIG. 4(c), if the tilting angle remains in the pre-defined range for longer than one second (or other pre-defined time), the zoom-out action will begin and the image of the fish (301) will shrink, as shown in FIG. 3(g). The corresponding waveforms of the motion sensor outputs during this situation are shown in FIG. 5(b) at time T3g. This zoom-out action ceases if the tilting angle is moved out of range or when the camera (103) reaches minimum size reduction. In this example, when the portable electronic device (100) is tilted back to landscape orientation, the image (301) on the video display (111) remains at the last size reduction, as shown in FIG. 3(h). During landscape orientation in camera mode, if the device (100) tilts left for a time shorter than 0.8 seconds and longer than 0.3 seconds (or some other pre-defined time interval) and immediately moves back to landscape orientation, then the camera will be triggered to begin video recording. The activity indicator (303) will also change its display to “MOVIE,” as shown in FIG. 3(h). This logic is also described in the flow chart in FIG. 4(c). Corresponding waveforms for this motion pattern are shown in FIG. 5(b) at time T3h. According to the flow chart in FIG. 4(c), a double shake would stop the recording; triple shakes at any time during camera operation will turn off the camera and return to the app selection mode shown in FIG. 2(a); two consecutive double shakes will also turn off the camera and cause the device to return to app selection mode as shown in FIG. 2(e). These examples of algorithms show that the need for a nob, switch, button, or touch screen can be eliminated using pre-defined motion patterns detected by a motion sensor (110). These methods are therefore ideal for controlling cameras underwater, or at any time where conventional control methods are unreliable. Similar types of control methods are also applicable for operations on land.

While the preferred embodiments have been illustrated and described herein, other modifications and changes will be evident to those skilled in the art. It is to be understood that there are many other possible modifications and implementations so that the scope of the invention is not limited by the specific embodiments discussed herein. Camera functions, including picture taking, starting a recording, stopping a recording, zooming-in, and zooming-out are discussed herein. Other types of camera functions such as enabling flash, switching to portrait mode, or adjusting exposure also can be executed using similar methods.

For example, while in camera zoom mode as shown in FIG. 4(c), two quick and consecutive right tilts are detected within a short time interval such as 2 seconds. This motion pattern, which will be referred to as a “double fast right tilt” in the remaining discussion, will trigger the device to shift into camera focus adjustment mode. Similarly, two quick and consecutive left tilts, which will be referred to as a “double fast left tilt” in the remaining discussion, triggers the camera to switch to shutter speed adjustment mode, as shown by FIG. 4(c).

Cameras are often equipped with light sources such as flash lights. Flash lights are very useful for taking pictures in darkness, but the brightness of flash lights is often too bright or too dark. It is there desirable to be able to adjust the brightness of camera light sources using contactless control mechanisms. FIG. 4(d) is a simplified flow chart for adjusting the brightness of the light source (105) beneath the rear-facing camera (103) in FIG. 1(a). If the device (100) is tilted left and the tilting angle is within pre-defined ranges, such as between 15 degrees and 45 degrees, and if the tilting angle remains in the pre-defined range for longer than a pre-defined time such as one second, then the brightness is adjusted to be darker. This darkening action ceases when the tilting angle is moved out of range, or when the brightness reaches a minimum value. If the device (100) is tilted right and the tilting angle is within pre-defined ranges, and if the tilting angle remains in the pre-defined range for greater than a pre-defined time such as one second, then the brightness is increased. This brightness increasing action ceases when the tilting angle is moved out of range, or when the brightness reaches a maximum value, as shown by the flow chart in FIG. 4(d). Similar to the algorithm in FIG. 4(c), a quick left tilt can be used to take pictures, a quick right tilt can trigger the device to begin video recording, a double shake can stop the device from recording, two consecutive quick double tilts can cause the device to switch from parameter adjustment mode to different camera operations, and three consecutive shakes at any time during camera operation can turn off the camera, as shown in FIG. 4(d).

Other Camera operation parameters, such as shutter speed, focal length, aperture width, and other parameters can be adjusted using motion sensor outputs by similar methods as illustrated by the flow chart in FIG. 4(e). While adjusting a parameter, if the device (100) is tilted left and the tilting angle is within pre-defined ranges, such as between 15 degrees and 45 degrees, and if the tilting angle remains in the pre-defined range for longer than a pre-defined time such as one second, then the value of the parameter is decreased. This parameter decreasing action ceases when the tilting angle is moved out of range, or when the parameter reaches a minimum value. If the device (100) is tilted right and the tilting angle is within pre-defined ranges, and if the tilting angle remains in the pre-defined range for greater than a pre-defined time such as one second, then the value of the parameter is increased. This parameter increasing action ceases when the tilting angle is moved out of range, or when the parameter reaches a maximum value, as shown by the flow chart in FIG. 4(e). Similar to the algorithm in FIG. 4(c), a quick left tilt can be used to take pictures, a quick right tilt can trigger the device to begin video recording, a double shake can stop the device from recording, two consecutive quick double tilts can cause the device to switch from parameter adjustment mode to different camera operations, and three consecutive shakes at any time during camera operation can turn off the camera, as shown in FIG. 4(e).

While the preferred embodiments have been illustrated and described herein, other modifications and changes will be evident to those skilled in the art. It is to be understood that there are many other possible modifications and implementations so that the scope of the invention is not limited by the specific embodiments discussed herein. For the above examples, all functions can be executed without the z component (Az) of the motion sensor (110) output. Therefore, a two-dimensional motion sensor can also accomplish the same purposes. The Az component, however, can still be of use. For example, Az can be used to recognize the situations when the portable electronic device is not held vertically. Az also can be used to detect push or pull motions as shown by the following example.

A portable electronic device can comprise multiple cameras (103, 113), as shown by the example in FIGS. 1(a, b). FIG. 4(f) is a simplified flow chart for an example of switching cameras using motion patterns determined by motion sensor outputs. During camera operation modes, if the user pushes the portable electronic device (100) forward three times, then the motion sensor will detect three positive pulses along the z axis, as shown by the waveforms in FIG. 5(c) at times T1′, T2′, and T3′. If the front-facing camera (113) is currently on, this triple push motion pattern will cause the device to switch cameras by turning on the rear-facing camera (103) and turning off the front-facing camera (113). If the user pulls the portable electronic device (100) backwards two times, the motion sensor will detect two negative pulses along z axis, as shown by the waveforms in FIG. 5(c) at times “T1” and “T2.” If the rear-facing camera (103) is currently on, this double-pull motion pattern will trigger the camera to turn on the front-facing camera (113) and turn off the rear-facing camera (103).

While specific embodiments of the invention have been illustrated and described herein, it is realized that other modifications and changes will occur to those skilled in the art. For example, specific motion patterns are discussed hereinbefore, but a wide variety of other motion patterns can be used as control methods of the present invention. It is to be understood that there are multiple other possible modifications and implementations so that the scope of the invention is not limited by the specific embodiments discussed herein. The appended claims are intended to cover all modifications and changes that fall within the true spirit and scope of the invention.

What is claimed is:

1. A method of operating a portable electronic device that comprises a digital camera, a video display device that can display video images captured by the digital camera, a motion sensor that can be used to determine the orientation of the electronic device, a water-tight enclosure that encloses the digital camera, the video display device, and the motion sensor, where the water-tight enclosure is transparent in the area of the optical lens of the camera, where this method of operating the portable device uses the motion sensor outputs to determine motion patterns of the portable electronic device to control picture taking or video recording functions, where said portable electronic device is a device that can operate using power provided by an internal battery, and a digital camera is a camera comprising a digital electrical signal interface for outputting image information captured by the camera and for controlling camera functions.

2. The method of operating a portable electronic device in claim 1 further comprises a method of using the motion sensor outputs to determine zoom in or zoom out camera operations.

3. The method of operating a portable electronic device in claim 1 further comprises a method of using the motion sensor outputs to adjust the time at which the shutter of the digital electronic camera opens and adjust how long the shutter stays open.

4. The method of operating a portable electronic device in claim 1 further comprises a method of using the motion sensor outputs to adjust the aperture opening of the digital electronic camera.

5. The method of operating a portable electronic device in claim 1 further comprises a method of using the motion sensor outputs to determine the location of a cursor displayed on the video display device.

6. The method of operating a portable electronic device in claim 1 further comprises a method of using the motion sensor outputs to determine launch and activation of application programs.

7. The method of operating a portable electronic device in claim 1 further comprises a method of using the motion sensor outputs to switch between front-facing and rear-facing cameras.

8. A method of operating a portable electronic device that comprises a digital camera, a video display device that can display video images captured by the digital camera, and a motion sensor that can be used to determine the orientation of the motion sensor, where this method of operating the portable device uses the motion sensor outputs to determine motion patterns of the portable electronic device and determine camera zoom in or zoom out functions based on the motion patterns determined from outputs of the motion sensor, where a portable electronic device is an electronic device that can operate using power provided by an internal battery, and a digital camera is a camera having a digital electrical signal interface for outputting image information captured by the camera and for controlling the functions of the camera.

9. The method of operating a portable electronic device in claim 8 further comprises a method using the motion sensor outputs to determine when to take a picture or record a video.

10. The method of operating a portable electronic device in claim 8 further comprises a method of using the motion sensor outputs to adjust the time at which the shutter of the digital electronic camera opens and adjust how long the shutter stays open.

11. The method of operating a portable electronic device in claim 8 further comprises a method of using the motion sensor outputs to adjust the aperture opening of the digital electronic camera.

12. The method of operating a portable electronic device in claim 8 further comprises a method of using the motion sensor outputs to determine the location of a cursor displayed on the video display device.

13. The method of operating a portable electronic device in claim 8 further comprises a method of using the motion sensor outputs to determine launch and activation of application programs.

14. The method of operating a portable electronic device in claim 8 further comprises a method of using the motion sensor outputs to switch between front-facing and rear-facing cameras.

15. A method of operating a portable electronic device that comprises a battery, a light source with electronically adjustable light brightness and a motion sensor that can be used to determine the orientation of the portable device, where this method of operating the portable device uses the motion sensor outputs to determine motion patterns of the portable electronic device and uses these motion patterns to adjust the brightness of the light emitted by the light source, where a portable electronic device is an electronic device that can operate using power provided by an internal battery.

16. The method of operating a portable electronic device in claim 15 further comprises a method using the motion sensor outputs to determine when to turn on or turn off the light source.
